(19) United States
(12) Patent Application Publication
(10) Pub. No.: US 2008/0130921 A1
(43) Pub. Date: Jun. 5, 2008

(54) PIEZOELECTRIC ELECTROACOUSTIC TRANSDUCER

(75) Inventors: Yasukazu Tokuhisa, Gunma (JP); Hiroaki Uenishi, Gunma (JP); Yoshiyuki Watanabe, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 11/773,339

(22) Filed: Jul. 3, 2007

(30) Foreign Application Priority Data
Jul. 5, 2006 (JP) 2006-211418

(51) Int. Cl. H04R 17/00

(52) U.S. Cl. 381/190

(57) ABSTRACT

A piezoelectric electroacoustic transducer capable of uniformly adhering the periphery of a piezoelectric diaphragm to an annular holding part of the holding body over the whole circumference is provided. The piezoelectric electroacoustic transducer includes a pair of piezoelectric elements having external electrodes on one main surface, a piezoelectric diaphragm provided between the piezoelectric elements and adhered to both main surfaces of an insulation substrate and a holding body having an annular holding part along the periphery of the edge of the piezoelectric diaphragm. The diaphragm is provided with a aperture conductor in an inner area enclosed by the annular holding part to interconnect the connection electrodes on both main surfaces of the diaphragm. A pair of extracted parts respectively connected to the connection electrodes is formed on the periphery of the edge of the other main surface. Accordingly, the periphery of the edge of the diaphragm can be uniformly adhered to the annular holding part of the holding body over the whole circumference with no necessity of providing an extracted part of the connection electrode on an adhesion surface between the periphery of the edge of the diaphragm and the holding part.

### BACKGROUND OF THE INVENTION

1. Field of the Invention

The present invention relates to a piezoelectric electroacoustic transducer used for a speaker and the like for a cellular phone and a mobile data terminal, particularly and concretely, a piezoelectric electroacoustic transducer having a structure that a bimorph type piezoelectric diaphragm is adhered at a peripheral part thereof to a holding body.

2. Description of the Related Technology

A piezoelectric electroacoustic transducer such as a piezoelectric speaker and a microphone has been widely used as simple electroacoustic transducer means. Especially in recent years, it has been often used as a speaker for a cellular phone, a mobile data terminal and the like.

As shown as an example in FIG. 13 (JP-A-H09-163497), well known has been a piezoelectric electroacoustic transducer 1 in which (1) a piezoelectric diaphragm 5 provided with a piezoelectric element 7 adhered thereto is held on a case 4b by adhesion so that the periphery of an edge of the piezoelectric diaphragm 5 would be placed upon an annular step part 4e of the case 4b and (2) a reed 9 connected to an electrode of the piezoelectric element 7 of the piezoelectric diaphragm 5 is extracted to the outside of the case 4b from a surface on which the periphery of an edge of the piezoelectric diaphragm 5 is placed upon the annular step part 4e.

An electrode formed on one main surface of the piezoelectric element 7 is adhered to one main surface of a substantially circular metal plate 6 to be electrically connected to the metal plate 6. Further, the electrode is electrically extracted to the outside of the case 4b through a reed 8 extended from the metal plate 6. An electrode formed on the other main surface of the piezoelectric element 7 is connected to the reed 9. The reed 9 is extracted to the outside of the case 4b from a surface on which a peripheral part of the piezoelectric diaphragm 5 is placed upon the annular step part 4e provided on an inner circumferential surface of the case 4b.

As described in Description of the Related Art, in a piezoelectric electroacoustic transducer, a piezoelectric diaphragm 5 provided with a piezoelectric element 7 adhered thereto is held on a case 4b used as a holding body by adhesion so that the periphery of an edge of the piezoelectric diaphragm 5 would be placed upon an annular step part 4e of the case 4b. The reed 9 connected to the other electrode of the piezoelectric element 7 of the piezoelectric diaphragm 5 is extracted to the outside of the case 4b so as to be projected from a surface of the piezoelectric diaphragm. Accordingly, the piezoelectric diaphragm 5 cannot be uniformly adhered to the annular step 4e of the case 4b over the whole circumference on the periphery of the edge of the piezoelectric diaphragm 5. This causes a problem that dispersion occurs easily in acoustic properties.

### SUMMARY OF CERTAIN INVENTIVE ASPECTS

In view of the above, an object of the invention is to provide a piezoelectric electroacoustic transducer capable of uniformly adhering the piezoelectric diaphragm to an annular holding part of the holding body over the whole circumference on the periphery of the edge of the piezoelectric diaphragm.

In accordance with first inventive aspect, the object can be achieved by a piezoelectric electroacoustic transducer comprising: a piezoelectric diaphragm formed from a diaphragm, a first piezoelectric element adhered to one main surface of the diaphragm and a second piezoelectric element adhered to the other main surface of the diaphragm; and a holding body for holding the piezoelectric diaphragm, the piezoelectric electroacoustic transducer wherein the first and second piezoelectric elements respectively include one or more pairs of external electrodes on at least one main surface adhered to the diaphragm, the diaphragm is provided on each of one and the other main surfaces of an insulation substrate with one or more pairs of connection electrodes correspondently connected to the external electrodes of the piezoelectric elements, the holding body includes an annular holding part extending along the periphery of an edge of the piezoelectric diaphragm and holds the piezoelectric diaphragm so that the piezoelectric diaphragm can vibrate by placing the periphery of the edge of one main surface of the piezoelectric diaphragm upon the annular holding part for adhesion, and the diaphragm is further provided with a aperture in an inner area enclosed by the annular holding part of the holding body, the aperture provided inside with a aperture conductor to conductively connect the connection electrodes on one and the other main surfaces of the diaphragm with each other, and the diaphragm is provided on the periphery of the edge of the other main surface thereof with a pair of extracted parts respectively connected to the connection electrodes.

In accordance with the first inventive aspect, in the piezoelectric diaphragm, no extracted part of the connection electrode is provided on an adhesion surface between the periphery of the edge of one main surface of the diaphragm and the annular holding part of the holding body in spite of a bimorph structure that the piezoelectric element are adhered to the both main surfaces of the diaphragm. Accordingly, the piezoelectric diaphragm can be uniformly adhered to the annular holding part of the holding body over the whole circumference on the periphery of the edge of the piezoelectric element diaphragm. This allows a piezoelectric electroacoustic transducer capable of achieving predetermined acoustic properties without dispersion to be provided.

Further, second inventive aspect can provide, in addition to the first inventive aspect, the piezoelectric electroacoustic transducer wherein the diaphragm is provided with a aperture in the shape of a trapezoid in cross section in the thickness direction, the aperture provided inside with the aperture conductor.

In accordance with the second inventive aspect, the connection electrode and the aperture conductor are continuously formed. This allows the connection to be improved in reliability.

Moreover, third inventive aspect can provide, in addition to the first inventive aspect, the piezoelectric electroacoustic transducer wherein the connection electrodes on one main surface of the diaphragm and the connection electrodes on the other main surface are conductively connected to each other via plural aperture conductors.

In accordance with the third inventive aspect, the connection between the connection electrodes can be maintained even in the case that a defect in connection occurs in one of the plural aperture conductors.

Furthermore, fourth inventive aspect can provide, in addition to the first inventive aspect, the piezoelectric electroacoustic transducer wherein the diaphragm is provided with a slit-shaped aperture provided inside with the aperture conductor.

In accordance with the fourth inventive aspect, the connection electrode and the aperture conductor are continuously formed. This allows the connection to be improved in reliability.

The above and other objects, characteristics and advantages of the foregoing inventive aspects will be made clear from the following detailed description and the attached drawings.

### BRIEF DESCRIPTION OF THE DRAWINGS

FIG. 1 is a perspective view of a whole appearance of a piezoelectric electroacoustic transducer in accordance with Embodiment 1 of the invention;

FIG. 2 is an exploded perspective view illustrating an inner structure of Embodiment 1;

FIG. 3 is an exploded perspective view illustrating an inner structure of a diaphragm used for the piezoelectric electroacoustic transducer in accordance with Embodiment 1;

FIG. 4 is an enlarged sectional view of a aperture conductor of a diaphragm used for the piezoelectric electroacoustic transducer in accordance with Embodiment 1;

FIG. 5 is a perspective view of a whole appearance of an example of a piezoelectric element used for a piezoelectric electroacoustic transducer in accordance with Embodiment 1;

FIG. 6 illustrates an inner structure of the piezoelectric element in cross section.

FIG. 7 is an exploded perspective view illustrating an inner structure of the piezoelectric element.

FIG. 8 is a perspective view of a whole appearance of a piezoelectric electroacoustic transducer in accordance with Embodiment 2 of the invention;

FIG. 9 is an exploded perspective view illustrating an inner structure of Embodiment 2;

FIG. 10 is an exploded perspective view illustrating an inner structure of a diaphragm used for the piezoelectric electroacoustic transducer in accordance with Embodiment 2;

FIG. 11 is an exploded perspective view illustrating an inner structure of the piezoelectric electroacoustic transducer in accordance with Embodiment 3 of the invention;

FIG. 12 is an exploded perspective view illustrating an inner structure of a diaphragm used for the piezoelectric electroacoustic transducer in accordance with Embodiment 3; and

FIG. 13 is an exploded perspective view illustrating a piezoelectric electroacoustic transducer in the related art.

### DETAILED DESCRIPTION OF CERTAIN INVENTIVE EMBODIMENTS

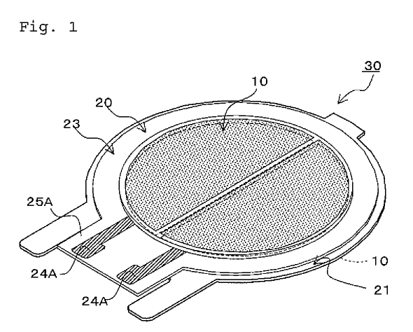

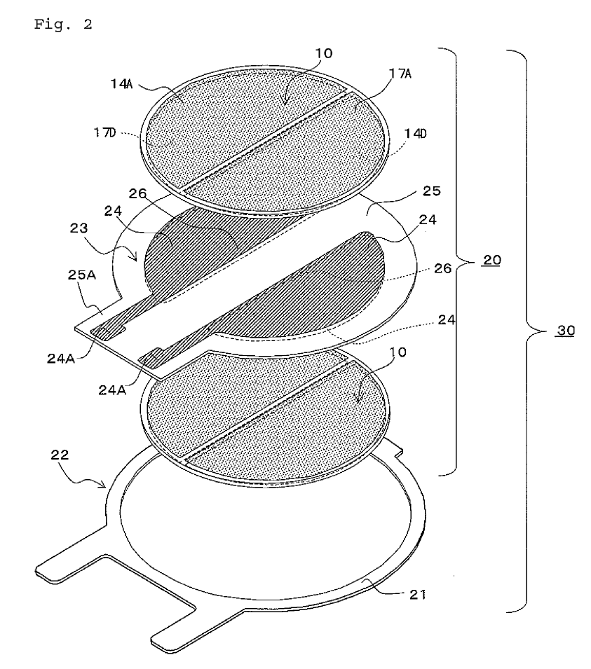

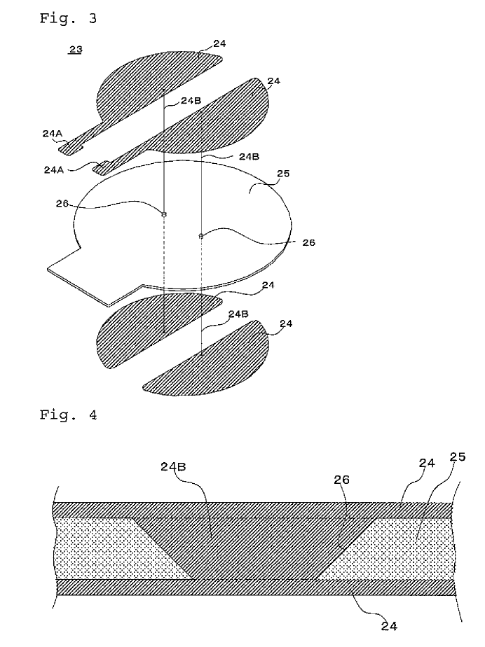

A piezoelectric electroacoustic transducer in accordance with Embodiment 1 of the invention will be described hereinafter, made reference to FIGS. 1 to 4. FIG. 1 is a perspective view of a whole appearance of a piezoelectric electroacoustic transducer 30 in accordance with Embodiment 1. FIG. 2 is an exploded perspective view illustrating an inner structure of the piezoelectric electroacoustic transducer 30 in accordance with Embodiment 1. FIG. 3 is an exploded perspective view illustrating an inner structure of a diaphragm 23 used for the piezoelectric electroacoustic transducer 30. FIG. 4 is an enlarged sectional view of a part of a aperture conductor 24B of the diaphragm 23.

The piezoelectric electroacoustic transducer 30 in accordance with Embodiment 1 includes, as shown in FIGS. 1, 2 and 3, disc-shaped first and second piezoelectric elements 10, each of which is provided with a pair of external electrodes 14 and 17 on each of one main surface of the piezoelectric element 10, the main surface adhered to the diaphragm 23, and the other main surface, the substantially disc-shaped diaphragm 23 provided on each of one and the other main surfaces of an insulation substrate 25 with a pair of connection electrodes 24 connected correspondently to the external electrodes 14 and 17 of the piezoelectric element 10 and a holding body 22 having an annular holding part 21 for holding the periphery of an edge of one main surface of the diaphragm 23 by adhesion. The insulation substrate 25 is provided with a projection part 25A extended in the outer circumferential direction. On the other main surface of the diaphragm 23, formed are extracted parts 24A extended from the pair of connection electrodes 24 to the convex part 25A of the insulation substrate 25.

Concretely, the piezoelectric electroacoustic transducer 30 in Embodiment 1 includes a piezoelectric diaphragm 20, which is formed from the substantially disc-shaped diaphragm 23, the substantially disc-shaped first piezoelectric element 10 adhered to one main surface of the diaphragm 23 and the substantially disc-shaped second piezoelectric element 10 similarly adhered to the other main surface of the diaphragm 23, and the holding body 22 for holding the piezoelectric diaphragm 20. Each of the first and second piezoelectric elements 10 includes a pair of external electrodes 14 and 17 on each of one main surface adhered to the diaphragm 23 and the other main surface. The diaphragm 23 is provided on each of one and the other main surfaces of the insulation substrate 25 with a pair of connection electrodes 24 and 24 correspondently connected to the external electrodes 14 and 17 of the piezoelectric element 10. The holding body 22 includes the annular holding part 21 extending along the periphery of the edge of the piezoelectric diaphragm 20. The holding body 22 holds the piezoelectric diaphragm 20 so that the piezoelectric diaphragm 20 can vibrate by placing the periphery of the edge of one main surface of the piezoelectric diaphragm 20 upon the annular holding part 21 for adhesion. The diaphragm 23 is further provided with apertures 26 in an inner area enclosed by the annular holding part 21 of the holding body 22. The aperture 26 is provided inside with the aperture conductor 24B to conductively connect the connection electrodes 24 and 24 on one and the other main surfaces of the diaphragm 23 with each other. The diaphragm 23 is also provided on the periphery of the edge of the other main surface thereof with a pair of extracted parts 24A and 24A respectively connected to the connection electrodes 24 and 24.

In the diaphragm 23 used for the piezoelectric electroacoustic transducer 30 in accordance with Embodiment 1, formed are the apertures 26 in the shape of a trapezoid in cross section in the thickness direction at the predetermined places of the substantially circular insulation substrate 25, as shown in FIGS. 3 and 4. The connection electrodes 24 and 24 respectively provided on one and the other main surfaces of the insulation substrate 25 are conductively connected with each other via the aperture conductors 24B provided inside the apertures 26. Concretely, on the other main surface of the insulation substrate 25, which is not placed upon the annular holding part 21 of the holding body 22, provided is a pair of substantially semicircular connection electrodes 24 to be connected to the external electrodes 14 and 17 of the piezoelectric element 10. The extracted parts 24A of the connection electrodes 24 respectively extend to the convex parts 25A extending in the outer circumferential direction of the insulation substrate 25. On the main surface of the insulation substrate 25, which is placed upon the annular holding part 21 of the holding body 22, provided is a pair of connection electrodes 24 having no extracted part 24A. The connection electrodes 24 on one main surface of the insulation substrate 25 and the connection electrodes 24 on the other main surface are conductively connected to each other via the aperture conductors 24B provided inside the apertures 26 in the shape of a trapezoid in cross section in the thickness direction, the apertures 26 being provided in the insulation substrate 25.

For the insulation substrate 25, preferable is an insulation film formed from an insulative material superior in bending characteristic such as PET (polyethylene terephthalate), for example. The material, however, is not limited to PET. It may be properly selected from PEN, polyimide, amide and an insulative resin film having equivalent heat resistance. The thickness of the diaphragm is preferably from 25 μm to 100 μm.

For the connection electrode 24 and the aperture conductor 24B of the diaphragm 23, preferable are a conductive metal powder made of Ag, Ni, Cu, Al and such and conductive resin containing an insulative resin such as ultraviolet-curable resins and thermosetting resins as a main component, especially, a polymeric conductive paste containing an Ag powder. A conductive resin paste formed by mixing a conductive metal powder, the insulative resin and a solvent can be applied, dried, and then, irradiated with ultraviolet rays or heated in accordance with necessity and cured to form the connection electrode 24 and the aperture conductor 24B. The thickness of the connection electrode is preferably from 4 to 20 μm.

The aperture 26 provided in the insulation substrate 25 of the diaphragm 23 may be provided anywhere so long as it is provided in the inner part of the diaphragm 23, which is enclosed by the annular holding part 21 of the holding body 22.

The aperture 26 may be formed in the insulation substrate 25 by punching simultaneously with punching of the insulation substrate 25 by means of a punching press or in a cutting process with a milling machine preceding or subsequent to the punching process. The way of forming the aperture 26 is not limited to the above. It is also possible to irradiate a surface of the insulation substrate 25 with a laser beam to form the aperture 26.

The shape of the aperture 26 is not specifically limited and may be properly selected from, for example, a circle, a rectangle, a slit and the like. Further, the shape of the aperture 26 in section in the thickness direction of the insulation substrate 25 is not limited to a cylinder. Various kinds of cross section such as a trapezoid and a drum may be considered. Moreover, an edge of an opening of the aperture 26 may be beveled or curved.

As for the dimension of the aperture conductor 24B, the diameter of an opening of the aperture conductor 24B at a part having the minimum sectional area in the thickness direction of the diaphragm 23 is preferably 0.5 to 100 times as much as the thickness of the diaphragm 23. This allows a defect in connection or deterioration in sound pressure at a resonance frequency to be prevented. When the diameter is smaller than a value 0.5 times as much as the thickness, electric charges concentrate in the aperture conductor to generate heat, which causes a defect in connection, in some cases. On the other hand, the rigidity of the diaphragm is easily deteriorated to lower the sound pressure at a resonance frequency when the diameter is larger than a value 100 times as much as the thickness.

For an adhesive used for adhesion of the diaphragm 23 and the piezoelectric element 10, preferable is a non-conductive adhesive, particularly, an anaerobic adhesive curable with ultraviolet rays.

For an adhesive used for adhesion of the periphery of the edge of the diaphragm 23 and the annular holding part 21 of the holding body 22, used may be an adhesive similar to the adhesive for adhesion of the diaphragm 23 and the piezoelectric element 10. The adhesive is not limited to the above. Various kinds of adhesive may be used. Furthermore, the way of adhesion is not limited to application of an adhesive. The adhesion may be achieved by a double-faced adhesive and such.

Now, an example of a manufacturing process of the piezoelectric electroacoustic transducer 30 in accordance with Embodiment 1 of the invention will be described, made reference to FIGS. 2 and 3.

First, a PET film of 50 μm in thickness undergoes a punching process by means of a punching press into the shape of a circle of 20 mm in diameter, the circle provided at a part thereof with the convex part 25A extended to the outer circumference. In a process preceding or subsequent to the punching process, the aperture 26 of 80 μm in diameter of an opening at a part having the minimum cross section in the thickness direction of the diaphragm is formed by irradiation with a laser beam to form the insulation substrate 25 provided with the aperture 26.

Then, as shown in FIG. 3, a polymeric conductive paste containing an Ag powder is applied to a main surface of the formed insulation substrate 25 by screen printing so that at least a part of the thickness of the printed film would be filled in the aperture 26. After the insulation substrate 25 is dried for 10 minutes at 100° C., a conductive resin paste is applied to the other main surface of the dried insulation substrate 25 similarly to the above to dry the insulation substrate 25 for 10 minutes at 100° C. After the above, the insulation substrate 25 is heated and cured for 10 minutes at 150° C. to form the diaphragm 23 having a pair of connection electrodes 24 on each of the front and back surfaces of the insulation substrate 25.

Following to the above, the periphery of the edge of the diaphragm 23 is adhered to the annular holding part 21 of the ring-shaped holding body 22 by means of a double-faced adhesive omitted from drawing, as shown in FIG. 2. The respective piezoelectric elements 10 are then adhered to the both main surfaces of the diaphragm 23 to form the piezoelectric electroacoustic transducer 30 in accordance with Embodiment 1.

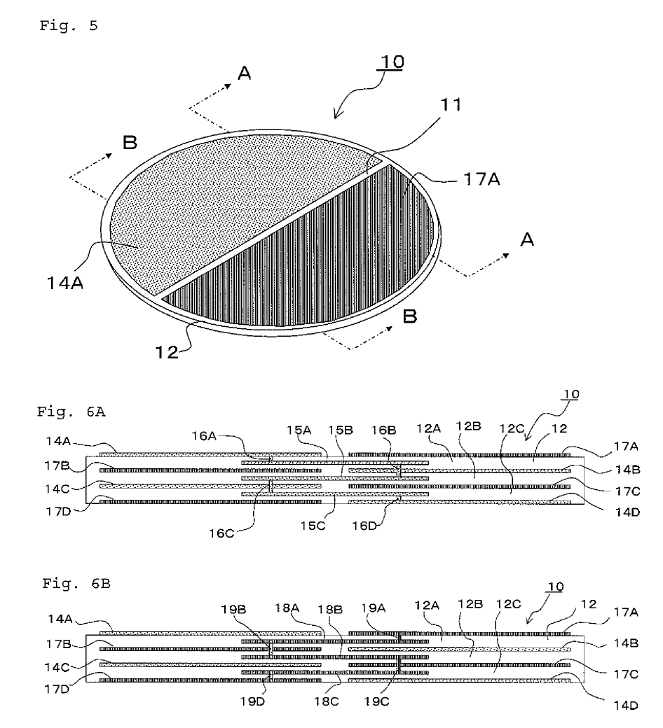

Now, an example of the piezoelectric element 10 used for the piezoelectric electroacoustic transducer 30 in accordance with Embodiment 1 will be described, made reference to FIGS. 5 to 7.

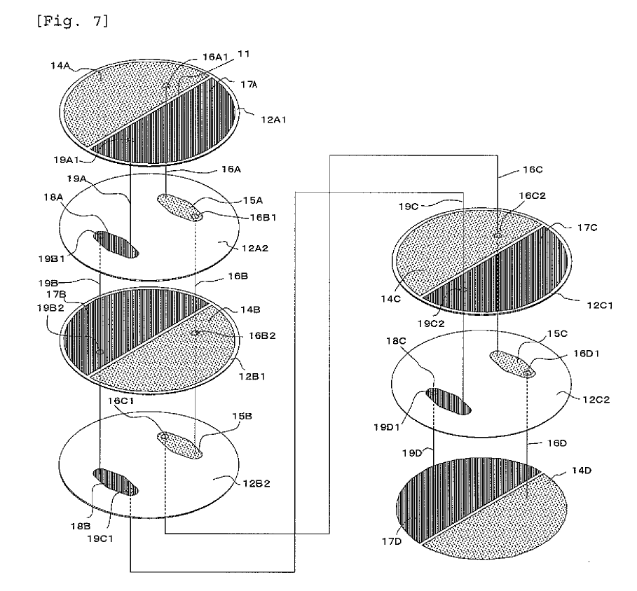

FIG. 5 is a perspective view of a whole appearance of an example of the piezoelectric element 10 used for a piezoelectric electroacoustic transducer 30 in accordance with Embodiment 1. FIG. 6 illustrates the piezoelectric element 10 shown in FIG. 5 in cross section. FIG. 6A is a sectional view taken along a line A-A in FIG. 5. FIG. 6B is a sectional view taken along a line B-B in FIG. 5. FIG. 7 is an exploded perspective view illustrating an inner structure of the piezoelectric element 10.

As shown in FIGS. 5 to 7, the piezoelectric element 10 includes a pair of external electrodes 14 and 17 on each of one main surface thereof, the main surface adhered to the diaphragm, and on the other main surface and is substantially in the shape of a disc. The piezoelectric element 10 has a substantially disc-shaped laminate body 12 comprising three piezoelectric layers 12A, 12B and 12C in the laminated direction. On a first main surface of at least one of the piezoelectric layers, the piezoelectric layer 12A, provided with an interval 11 are a first electrode 14A and a second electrode 17A. A third electrode 17B facing to the first electrode 14A and a fourth electrode 14B facing to the second electrode 17A are similarly provided with an interval therebetween on a second main surface of the piezoelectric layer 12A. The first electrode 14A and the fourth electrode 14B are connected through a connection conductor 15A on a surface different from the both of the first and second main surfaces of the laminate body 12, a aperture conductor 16A connecting the connection conductor 15A and the first electrode 14A and a aperture conductor 16B connecting the connection conductor 15A and the fourth electrode 14B. The second electrode 17A and the third electrode 17B are connected through a connection conductor 18A on a surface different from the both of the first and second main surfaces of the laminate body 12, a aperture conductor 19A connecting the connection conductor 18A and the second electrode 17A and a aperture conductor 19B connecting the connection conductor 18A and the third electrode 17B.

Accordingly, when signal voltages having different polarities are respectively applied to the first electrode 14A and the second electrode 17A on one main surface of the piezoelectric layer 12A, the signal voltage same as that of the first electrode 14A is applied to the fourth electrode 14B opposite to the second electrode 17A with respect to the piezoelectric layer 12A through the aperture conductor 16A, the connection conductor 15A and the aperture conductor 16B. Similarly, through the aperture conductor 19A, the connection conductor 18A and the aperture conductor 19B, the signal voltage same as that of the second electrode 17A is applied to the third electrode 17B opposite to the first electrode 14A with the piezoelectric layer 12A interposed there between. This causes the piezoelectric layer 12A between the respective electrodes to be displaced in the thickness/surface directions.

The piezoelectric element 10 includes the laminate body 12 having at least one piezoelectric layer 12A, as described above. In the remaining two piezoelectric layers 12B and 12C, electrodes, connection conductors and apertures are also formed and connected similarly to the case of the piezoelectric layer 12A although this is omitted from description.

Accordingly, in the piezoelectric element 10, when signal voltages having different polarities are respectively applied to the electrodes 14A and 17A on a surface of the laminate body 12, the voltage same as that of the first electrode 14A is applied to the electrodes 14B, 14C and 14D through the connection conductors 15A, 15B and 15C and the aperture conductors 16A, 16B, 16C and 16D. Further, the signal voltage same as that of the electrode 17A is applied to the electrodes 17B, 17C and 17D through the connection conductors 18A, 18B and 18C and the aperture conductors 19A, 19B, 19C and 19D.

This results in displacement of the respective piezoelectric layers 12A, 12B and 12C of the laminate body 12 in the thickness/surface directions in the piezoelectric element 10.

For the piezoelectric layers 12A, 12B and 12C of the piezoelectric element 10, preferable is one including as a main component a ceramics piezoelectric body, an organic piezoelectric body or a mixture of the above.

For the electrodes 14A to 14D and 17A to 17D, the connection conductors 15A to 15C and 18A to 18C and the aperture conductors 16A to 16D and 19A to 19D of the piezoelectric element 10, preferable is an electrode material such as Ag, Ag—Pd and Pd or a material formed by mixing the small quantity of piezoelectric material with the electrode material. The laminate body 12 of the piezoelectric element includes at least one piezoelectric layer, preferably, plural piezoelectric layers for the purpose of achieving larger displacement. It goes without saying that the laminate body may be formed from at least one of the piezoelectric layers and another insulation layer, which are laminated.

Now, described will be an outline of an example of a process of manufacturing the lamination type piezoelectric element 10 using a ceramics piezoelectric body as a piezoelectric layer, the manufacturing process using a sheet lamination method.

First, prepared is a powder of a PZT ceramic piezoelectric material. The power is mixed with a binder and a solvent to produce ceramics slurry. The slurry is used for coating on a carrier film made of PET (polyethylene terephthalate) or the like by a well-known method such as the doctor blade method and the gravure printing method. The carrier film is dried to form a long ceramic green sheet, which is 10 to 100 μm in thickness and contains a piezoelectric material as a main component. After the above, the sheet is cut into a predetermined dimension to form plural ceramic green sheets. Apertures are then formed in predetermined places of the formed ceramic green sheet by punching press or irradiation with a laser beam. Following to the above, prepared is a powder of an electrode material such as Ag, Ag—Pd or Pd. The prepared powder is mixed with a binder and a solvent to form an electrode material paste. The electrode material paste is used for printing electrodes and connection conductors on the ceramic green sheet with a predetermined pattern. The apertures are filled with aperture conductors. The ceramic green sheets are laminated and connected by pressure in a predetermined order so that the electrodes and the connection conductors would be in contact with the aperture conductors to form a ceramic laminate body. The ceramic laminate body undergoes a process for removing the binder at 400 to 800° C., and then, is sintered for 1 to 3 hours at 850 to 1100° C. to form a piezoelectric element formed from a laminate body. The above is an outline of the manufacturing process using the sheet lamination method. The manufacturing method for obtaining the piezoelectric element, however, is not limited to the sheet lamination method but may be formed by a well-known slurry building method as well as a method using an organic piezoelectric material, the method including a process similar to a process used for forming a printed wiring board.

An example of a process of manufacturing the piezoelectric element 10 will be now described by exemplifying the sheet lamination method.

First, prepared is a well-known powder of a PZT ceramic piezoelectric material. The powder is mixed with a binder and a solvent to produce ceramic slurry. The slurry is used for forming a long ceramic green sheet, which is 30 μm in thickness, on a PET film by the doctor blade method. The formed ceramic green sheet is cut into a predetermined dimension to form plural ceramic green sheets 12A1, 12A2, 12B1, 12B2, 12C1 and 12C2. For the sake of convenience, only one piezoelectric element is shown in the drawings (and so forth).

Then, irradiation with a laser beam is carried out to form apertures 16A1 and 19A1 at predetermined places of the ceramic green sheet 12A1, apertures 16B1 and 19B1 at predetermined places of the ceramic green sheet 12A2, apertures 16B2 and 19B2 at predetermined places of the ceramic green sheet 12B1, apertures 16C1 and 19C1 at predetermined places of the ceramic green sheet 12B2, apertures 16C2 and 19C2 at predetermined places of the ceramic green sheet 12C1, apertures 16D1 and 19D1 at predetermined places of the ceramic green sheet 12C2, respectively.

Following to the above, prepared is an electrode material paste formed by mixing a powder of a Pd electrode material, a binder and a solvent. The electrodes and the connection conductors are printed at predetermined places of the respective ceramic green sheets by the screen printing method while the apertures are filled with aperture conductors. In the first place, a pair of the connection conductors 15A and 18A is printed on one main surface of the ceramic green sheet 12A2. On the other hand, the apertures 16B1 and 19B1 are filled with the aperture conductors. Similarly, a pair of the connection conductors 15B and 18B is printed on one main surface of the ceramic green sheet 12B2. On the other hand, the apertures 16C1 and 19C1 are filled with the aperture conductors. Similarly, a pair of the connection conductors 15C and 18C is printed on one main surface of the ceramic green sheet 12C2 while the apertures 16D1 and 19D1 are filled with the aperture conductors. Moreover, the pair of the electrodes 14A and 17A is printed on one main surface of the ceramic green sheet 12A1. On the other hand, the apertures 16A1 and 19A1 are filled with the aperture conductors. Similarly, the pair of the electrodes 14B and 17B is printed on one main surface of the ceramic green sheet 12B1 while the apertures 16B2 and 19B2 are filled with the aperture conductors. Similarly, the pair of the electrodes 14C and 17C is printed on one main surface of the ceramic green sheet 12C1. On the other hand, the apertures 16C2 and 19C2 are filled with the aperture conductors. Furthermore, the pair of the electrodes 14D and 17D is printed on the other main surface of the ceramic green sheet 12C2.

The ceramic green sheets 12A1, 12A2, 12B1, 12B2, 12C1 and 12C2 are laminated and connected by pressure in order so that contact would be made between the electrodes and the aperture conductors and between the connection conductors and the aperture conductors, respectively. A process for removing a binder at a predetermined temperature is then carried out and sintering is performed for three hours at a predetermined temperature to form the laminate body 12. After the above, when polarized voltages having different polarities are respectively applied to the electrodes 14A and 17A on a surface of the laminate body 12, the voltage same as that of the electrode 14A is applied to the electrodes 14B, 14C and 14D through the aperture conductors 16A, 16B, 16C and 16D. The voltage same as that of the electrode 17A is applied to the electrodes 17B, 17C and 17D through the connection conductors 18A, 18B and 18C and the aperture conductors 19A, 19B, 19C and 19D.

As a result, the respective piezoelectric layers 12A, 12B and 12C of the laminate body 12 are polarized in the thickness direction in the piezoelectric element 10.

The piezoelectric element 10 has the laminate body 12 comprising at least one piezoelectric layer 12A. On a first main surface of the piezoelectric layer 12A, the first electrode 14A and a second electrode 17A are provided therebetween with an interval 11. The third electrode 17B facing to the first electrode 14A and the fourth electrode 14B facing to the second electrode 17A are similarly provided with an interval therebetween on a second main surface of the piezoelectric layer 12A. The first electrode 14A and the fourth electrode 14B are connected through the connection conductor 15A on a surface different from both of the first and second main surfaces of the laminate body 12. The second electrode 17A and the third electrode 17B are connected through the connection conductor 18A on a surface different from both of the first and second main surfaces of the laminate body 12.

The piezoelectric element 10, the diaphragm 23 and the piezoelectric diaphragm 20 in the above description are substantially formed into the shape of a disc, respectively. The shape, however, is just an example. The invention is not limited to the above. The piezoelectric element 10, the diaphragm 23 and the piezoelectric diaphragm 20 may be in any shape so long as they are in the shape of a plate. Further, the holding part 21 and the holding body 22 are substantially formed into the shape of a ring, respectively. This is, however, only an example. The invention is not limited to the above. The holding part 21 and the holding body 22 may be in any shape so long as the shape is annular and extends along the outer circumference of the piezoelectric diaphragm.

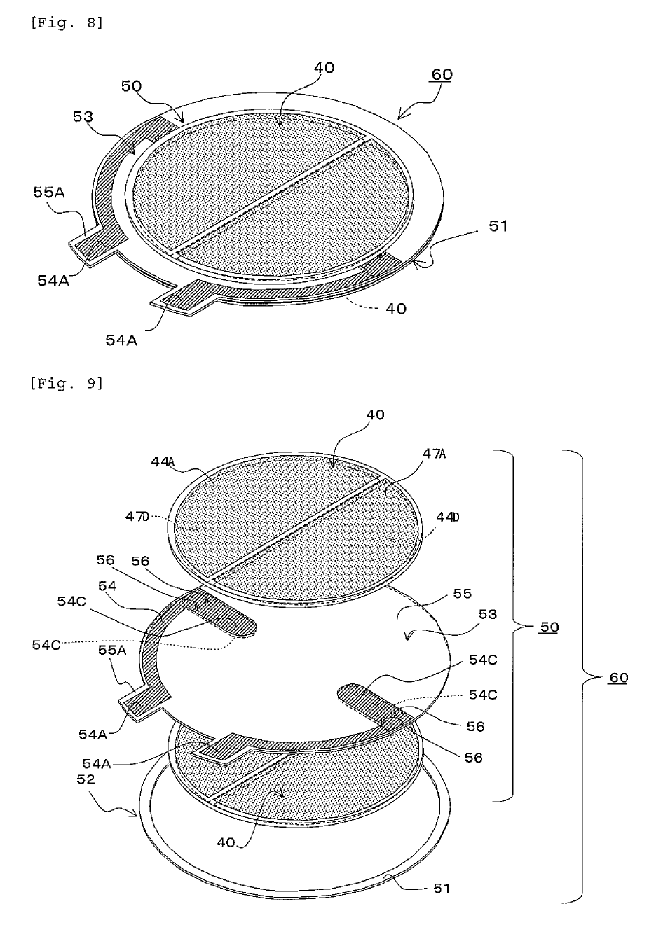

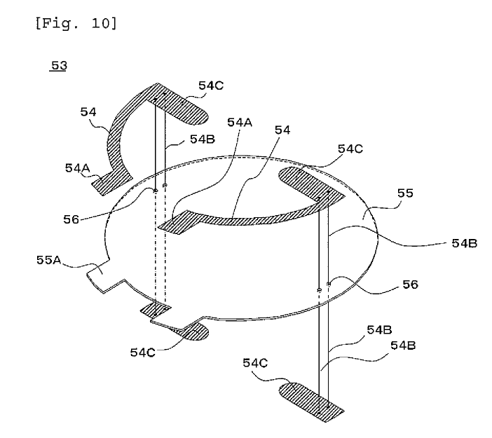

Now, a piezoelectric electroacoustic transducer in accordance with Embodiment 2 of the invention will be described, made reference to FIGS. 8 to 10. FIG. 8 is a perspective view of a whole appearance of a piezoelectric electroacoustic transducer 60 in accordance with Embodiment 2 of the invention. FIG. 9 is an exploded perspective view illustrating an inner structure of the piezoelectric electroacoustic transducer 60 in accordance with Embodiment 2. FIG. 10 is an exploded perspective view illustrating an inner structure of a diaphragm 53 used for the piezoelectric electroacoustic transducer 60 in accordance with Embodiment 2.

The piezoelectric electroacoustic transducer 60 in accordance with Embodiment 2 includes disc-shaped first and second piezoelectric elements 40 and 40 provided with a pair of substantially semicircular external electrodes 44 and 47 on each of one main surface of the element, which is adhered to the diaphragm 53, and the other main surface, the substantially disc-shaped diaphragm 53 provided on each of one and the other main surfaces of a flexible insulation substrate 55 with a pair of connection electrodes 54C correspondingly connected to the external electrodes 44 and 47 of a piezoelectric element 40, a holding body 52 including an annular holding part 51 for holding the periphery of an edge of the other main surface of the diaphragm 53 by adhesion. The insulation substrate 55 is provided with a pair of projections 55A extending to the outer circumferential direction. On the other main surface of the diaphragm 53, formed is an extracted part 54A extending from the pair of connection electrodes 54C to a convex part 55A of the insulation substrate 55.

Concretely, as shown in FIGS. 8, 9 and 10, the piezoelectric electroacoustic transducer in accordance with Embodiment 2 includes a piezoelectric diaphragm 50, which is formed from the substantially disc-shaped diaphragm 53, the substantially disc-shaped first piezoelectric element 40 adhered to one main surface of the diaphragm 53 and the substantially disc-shaped second piezoelectric element 40 similarly adhered to the other main surface of the diaphragm 53, and the holding body 52 for holding the piezoelectric diaphragm 50. Each of the first and second piezoelectric elements 40 include a pair of external electrodes on each of one main surface adhered to the diaphragm 53 and the other main surface. The diaphragm 53 is provided on each of one and the other main surfaces of the insulation substrate 55 with a pair of connection electrodes 54 and 54 correspondently connected to the external electrodes 44 and 47 of the piezoelectric elements 40. The holding body 52 includes the annular holding part 51 extending along the periphery of the edge of the piezoelectric diaphragm 50. The holding body 52 holds the piezoelectric diaphragm 50 so that the piezoelectric diaphragm 50 can vibrate by adhesion of the periphery of the edge of one main surface of the piezoelectric diaphragm 50 placed upon the annular holding part 51. The diaphragm 53 is further provided with apertures 56 in an inner area enclosed by the annular holding part 51 of the holding body 52. The aperture conductor 54B is provided inside the aperture 56 to conductively connect the connection electrodes 54C and 54C on one and the other main surfaces of the diaphragm 53 with each other. Each pair of extracted parts 54A and 54A respectively connected to the connection electrodes 54C and 54C is formed on the periphery of the edge of the other main surface of the diaphragm 53.

In the diaphragm 53 used for the piezoelectric electroacoustic transducer 60 in accordance with Embodiment 2, formed are the apertures 56 in the shape of a trapezoid in cross section in the thickness direction at the predetermined places of the substantially circular insulation substrate 55, as shown in FIG. 10. The connection electrodes 54C and 54C respectively provided on one and the other main surfaces of the insulation substrates 55 are conductively connected to each other via the aperture conductors 54B provided inside the apertures 56. Concretely, on the other main surface of the insulation substrate 55, which is not placed upon the annular holding part 51 of the holding body 52, provided is a pair of tongue-shaped connection electrodes 54C to be connected to the external electrodes 44 and 47 of the piezoelectric element 40. The extracted parts 54A of the connection electrodes 54C respectively extend to the convex parts 55A extending in the outer circumferential direction of the insulation substrates 55. On the main surface of the insulation substrate 55, which is placed upon the annular holding part 51 of the holding body 52, provided is a pair of tongue-shaped connection electrodes 54C having no extracted part 54A. The connection electrodes 54C on one main surface of the insulation substrate 55 and the connection electrodes 54C on the other main surface are conductively connected to each other via the aperture conductors 54B provided inside the apertures 56 in the shape of a trapezoid in cross section in the thickness direction, the apertures 56 being provided in the insulation substrate 55.

Further, in Embodiment 2, the connection electrode 54C on one main surface of the diaphragm 53 and the connection electrode 54C on the other main surface are conductively connected with each other via plural aperture conductors 56 and 56.

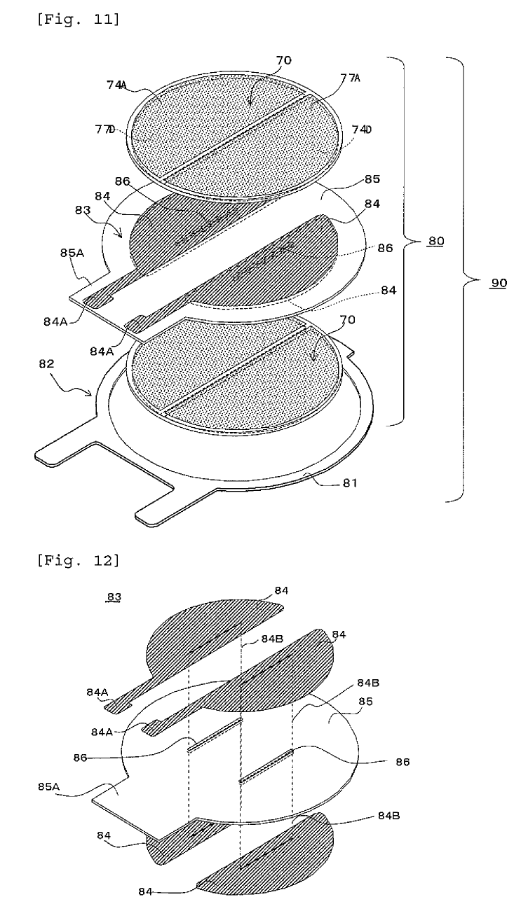

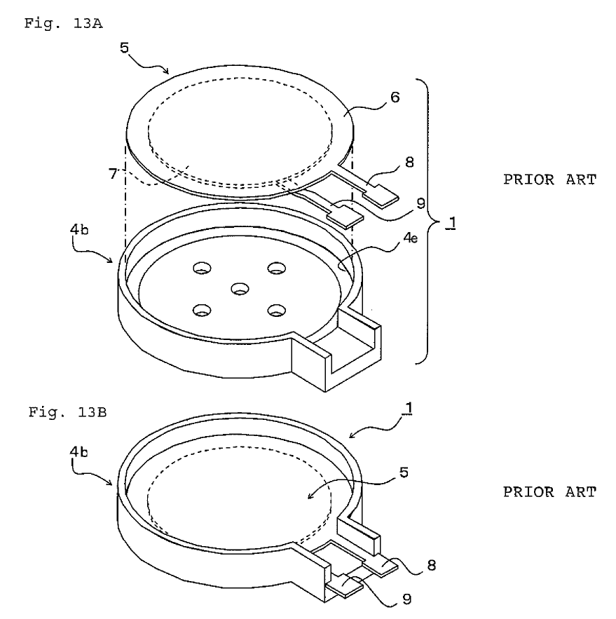

Now, a piezoelectric electroacoustic transducer in accordance with Embodiment 3 of the invention will be described, made reference to FIGS. 11 and 12. FIG. 11 is an exploded perspective view illustrating an inner structure of the piezoelectric electroacoustic transducer 90 in accordance with Embodiment 3. FIG. 12 is an exploded perspective view illustrating an inner structure of a diaphragm 83 used for the piezoelectric electroacoustic transducer 90 in accordance with Embodiment 3. The appearance of the piezoelectric electroacoustic transducer 90 in accordance with Embodiment 3 is omitted from drawing since it is similar to that of the piezoelectric electroacoustic transducer 30 in accordance with Embodiment 1.

As shown in FIGS. 11 and 12, the piezoelectric electroacoustic transducer 90 in accordance with Embodiment 3 includes disc-shaped first and second piezoelectric elements 70 provided with a pair of external electrodes 74 and 77 on each of one main surface of the element, which is adhered to the diaphragm 83, and on the other main surface, the substantially disc-shaped diaphragm 83 provided on each of one and the other main surfaces of a flexible insulation substrate 85 with a pair of connection electrodes 84 correspondingly connected to the external electrodes 74 and 77 of a piezoelectric element 70, a holding body 82 including an annular holding part 81 for holding the periphery of an edge of the other main surface of the diaphragm 83 by adhesion. The insulation substrate 85 is provided with a pair of projections 85A extending to the outer circumferential direction. On the other main surface of the diaphragm 83, formed is an extracted part 84A extending from the pair of connection electrodes 84 to a convex part 85A of the insulation substrate 85.

Concretely, the piezoelectric electroacoustic transducer 90 in accordance with Embodiment 3 includes a piezoelectric diaphragm 80, which is formed from the substantially disc-shaped diaphragm 83, the substantially disc-shaped first piezoelectric element 70 adhered to one main surface of the diaphragm 83 and the substantially disc-shaped second piezoelectric element 70 similarly adhered to the other main surface of the diaphragm 83, and the holding body 82 for holding the piezoelectric diaphragm 80. Each of the first and second piezoelectric elements 70 includes a pair of external electrodes 74 and 77 on each of one main surface adhered to the diaphragm 83 and the other main surface. The diaphragm 83 is provided on each of one and the other main surfaces of the insulation substrate 85 with a pair of connection electrodes 84 and 84 correspondently connected to the external electrodes 74 and 77 of the piezoelectric elements 70. The holding body 82 includes the annular holding part 81 extending along the periphery of the edge of the piezoelectric diaphragm 80. The holding body 82 holds the piezoelectric diaphragm 80 so that the piezoelectric diaphragm 80 can vibrate by adhesion of the periphery of the edge of one main surface of the piezoelectric diaphragm 80 placed upon the annular holding part 81. The diaphragm 83 is further provided with apertures 86 in an inner area enclosed by the annular holding part 81 of the holding body 82. The aperture conductor 84B is provided inside the aperture 86 to conductively connect the connection electrodes 84 and 84 on one and the other main surfaces of the diaphragm 83 with each other. Each pair of extracted parts 84A and 84A respectively connected to the connection electrodes 84 and 84 is formed on the periphery of the edge of the other main surface of the diaphragm 83.

In the diaphragm 83 used for the piezoelectric electroacoustic transducer 90 in accordance with Embodiment 3, formed are the slit-shaped apertures 86 at the predetermined places of the substantially circular insulation substrate 85, as shown in FIG. 12. The connection electrodes 84 and 84 respectively provided on one and the other main surfaces of the insulation substrates 85 are conductively connected to each other via the aperture conductors 84B provided inside the apertures 86. Concretely, on the other main surface of the insulation substrate 85, which is not placed upon the annular holding part 81 of the holding body 82, provided is a pair of substantially semicircular connection electrodes 84 to be connected to the external electrodes 74 and 77 of the piezoelectric element 70. The extracted parts 84A of the connection electrodes 84 respectively extend to the convex parts 85A extending in the outer circumferential direction of the insulation substrates 85. On the main surface of the insulation substrate 85, which is placed upon the annular holding part 81 of the holding body 82, provided is a pair of connection electrodes 84 having no extracted part 84A. The connection electrodes 84 on one main surface of the insulation substrate 85 and the connection electrodes 84 on the other main surface are conductively connected to each other via the aperture conductors 84B provided inside the slit-shaped apertures 86 formed in the insulation substrate 85.

In Embodiments 1 to 3, the external dimension of the board-shaped diaphragm is formed smaller than that of the holding body. The invention, however, is not limited to the above. The external dimension of the board-shaped diaphragm may be same as that of the holding body as shown in Embodiment 2, for example. Further, the external dimension of the diaphragm may be larger than that of the holding body.

Moreover, examples of a diaphragm preferable for a piezoelectric speaker are described as an example of a piezoelectric electroacoustic transducer in Embodiments 1 to 3. The invention, however, is not limited to the above and may be applicable to various kinds of piezoelectric electroacoustic transducer such as a piezoelectric receiver, a piezoelectric sounder and a piezoelectric microphone. Such a piezoelectric electroacoustic transducer can be applied to various kinds of well-known electronics.

Some of the foregoing embodiments are preferable for a piezoelectric electroacoustic transducer for electronics, which has been required to be thinner.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A piezoelectric electroacoustic transducer comprising: a piezoelectric diaphragm formed from a diaphragm, a first piezoelectric element adhered to one main surface of the diaphragm and a second piezoelectric element adhered to the other main surface of the diaphragm; and a holding body for holding the piezoelectric diaphragm, wherein
the first and second piezoelectric elements respectively comprise one or more pairs of external electrodes on at least one main surface adhered to the diaphragm,
the diaphragm is provided on each of one and the other main surfaces of an insulation substrate with one or more pairs of connection electrodes correspondently connected to the external electrodes of the piezoelectric elements,
the holding body comprises an annular holding part extending along the periphery of an edge of the piezoelectric diaphragm and holds the piezoelectric diaphragm so that the piezoelectric diaphragm vibrates by placing the periphery of the edge of one main surface of the piezoelectric diaphragm upon the annular holding part for adhesion; and
the diaphragm is further provided with a conductive path in an inner area enclosed by the annular holding part of the holding body, to conductively connect the connection electrodes on one and the other main surfaces of the diaphragm with each other.

2. The piezoelectric electroacoustic transducer according to claim 1, wherein the conductive path comprises an aperture.

3. The piezoelectric electroacoustic transducer according to claim 1, wherein the diaphragm is provided with an aperture in the shape of a trapezoid in cross section in the thickness direction, the aperture provided inside with an aperture conductor.

4. The piezoelectric electroacoustic transducer according to claim 1, wherein the connection electrodes on one main surface of the diaphragm and the connection electrodes on the other main surface are conductively connected to each other via aperture conductors.

5. The piezoelectric electroacoustic transducer according to claim 1, wherein the diaphragm is provided with a slit-shaped aperture provided inside with the aperture conductor.

6. The piezoelectric electroacoustic transducer according to claim 1, wherein the diaphragm is provided on the periphery of the edge of the other main surface thereof with a pair of extracted parts respectively connected to the connection electrodes.

7. A method of making a piezoelectric transducer, the method comprising:
electrically coupling electrodes on both sides of the transducer through an inner portion of the transducer; and
routing connection electrodes coupled to electrodes on both sides of the transducer off only one side of the transducer.
